(19) United States
(12) Patent Application Publication
(10) Pub. No.: US 2014/0011003 A1
(43) Pub. Date: Jan. 9, 2014

(54) TEMPORARY FRECKLE TATTOO

(71) Applicant: Armen Vahe Danielian, Woodland Hills, CA (US)

(72) Inventors: Elmon Bella Tanielian, Sandy, UT (US); Talin Ashkhen Tanielian, Sandy, UT (US); Armen Vahe Danielian, Woodland Hills, CA (US)

(21) Appl. No.: 13/935,203

(22) Filed: Jul. 3, 2013

Related U.S. Application Data
(60) Provisional application No. 61/669,532, filed on Jul. 9, 2012.

(51) Int. Cl. B44C 1/175

(52) U.S. Cl. CPC B44C 1/1758
USPC 428/195.1

(57) ABSTRACT

Described is a temporary freckle tattoo. Importantly, the invention includes an application sheet having temporary tattoo graphics thereon, the temporary tattoo graphics being formed to mimic freckles when applied to a user. Additionally, the application sheet includes a die-line that is shaped to assist application of the application sheet to a user's face.

### CROSS-REFERENCE TO RELATED APPLICATIONS

This is a non-provisional of U.S. Provisional Application No. 61/669,532, filed on Jul. 9, 2012, and entitled, “Temporary Freckle Tattoo.”

### BACKGROUND OF THE INVENTION

(1) Field of Invention

The present invention relates to a temporary tattoo and, more particularly, to a temporary tattoo that includes graphics that are formed to mimic freckles when applied to a user's face.

(2) Description of Related Art

The present invention is directed to cosmetic enhancement. In the cosmetic field, it is common for women to experiment with new cosmetics to change the way they look. Traditionally, women apply a variety of makeup to tint, color, etc. their face and alter their natural appearance.

To some women, freckles are quite attractive and desirable. In some cases, a woman without freckles may desire to have such facial markings. To accommodate this need, a market has developed to provide permanent freckle tattoos. In other words, it has become increasingly popular for women to obtain actual tattoos on their face that simulate the appearance of freckles. While functional for aesthetic enhancement, permanent tattoos are quite permanent.

Thus, a continuing need exists to allow women to experiment with new cosmetic looks and try out a temporary freckle before making a final decision to get a permanent freckle tattoo.

### SUMMARY OF INVENTION

The present invention relates to a temporary tattoo. Importantly, the invention includes an application sheet having temporary tattoo graphics thereon, the temporary tattoo graphics being formed to mimic freckles when applied to a user.

Additionally, the application sheet includes a die-line that is shaped to assist application of the application sheet to a user's. For example, the die-line on the application sheet includes a center high point to allow maximum freckle coverage on top of the user's nose.

In another aspect, the die-line on the application sheet includes curved reliefs on each side of the high point to allow the application sheet to circumvent a user's eyes when applied.

In yet another aspect, the die-line on the application sheet includes a center bottom that extends outward to cover a user's nose tip.

In another aspect, the die-line on the application sheet includes cutaways formed on each side of the center bottom to allow the application paper to flex three-dimensionally to conform to the user's nose and cheeks.

In yet another aspect, the die-line on the application sheet includes shallow cutaways around its perimeter to allow the application sheet to flex three-dimensionally.

Thus, as can be appreciated, the die-line of the application sheet is formed to easily conform to the irregular three dimensional curvature of the user's face and hence significantly improves the quality of the application. This die-line is also designed to keep the application paper away from the user's eyes.

Finally, as can be appreciated by one in the art, the present invention also comprises a method for forming and using the invention described herein.

### BRIEF DESCRIPTION OF THE DRAWINGS

The objects, features and advantages of the present invention will be apparent from the following detailed descriptions of the various aspects of the invention in conjunction with references to the following drawings, where:

FIG. 1 is an illustration of a marked line or die-line application sheet that can be used to apply temporary freckle tattoos to a user's face;

FIG. 2 is an illustration of a marked line or die-line application sheet that can be used to apply temporary freckle tattoos to a user's face;

FIG. 3 is an illustration of a marked line or die-line application sheet that can be used to apply temporary freckle tattoos to a user's face; and

FIG. 4 is an illustration of a marked line or die-line application sheet that can be used to apply temporary freckle tattoos to a user's face.

### DETAILED DESCRIPTION

The present invention relates to a temporary tattoo and, more particularly, to a temporary tattoo that includes graphics that are formed to mimic freckles when applied to a user's face. The following description is presented to enable one of ordinary skill in the art to make and use the invention and to incorporate it in the context of particular applications. Various modifications, as well as a variety of uses in different applications will be readily apparent to those skilled in the art, and the general principles defined herein may be applied to a wide range of embodiments. Thus, the present invention is not intended to be limited to the embodiments presented, but is to be accorded the widest scope consistent with the principles and novel features disclosed herein.

In the following detailed description, numerous specific details are set forth in order to provide a more thorough understanding of the present invention. However, it will be apparent to one skilled in the art that the present invention may be practiced without necessarily being limited to these specific details. in other instances, well-known structures and devices are shown in block diagram form, rather than in detail, in order to avoid obscuring the present invention.

The reader's attention is directed to all papers and documents which are filed concurrently with this specification and which are open to public inspection with this specification, and the contents of all such papers and documents are incorporated herein by reference. All the features disclosed in this specification, (including any accompanying claims, abstract, and drawings) may be replaced by alternative features serving the same, equivalent or similar purpose, unless expressly stated otherwise. Thus, unless expressly stated otherwise, each feature disclosed is only one example of a generic series of equivalent or similar features.

Furthermore, any element in a claim that does not explicitly state “means for” performing a specified function, or “step for” performing a specific function, is not to be interpreted as a “means” or “step” clause as specified in 35 U.S.C. Section 112, Paragraph 6. In particular, the use of “step of” or “act of” in the claims herein is not intended to invoke the provisions of 135 U.S.C. 112, Paragraph 6.

Please note, if used, the labels left, right, front, back, top, bottom, forward, reverse, clockwise and counter clockwise have been used for convenience purposes only and are not intended to imply any particular fixed direction. Instead, they are used to reflect relative locations and/or directions between various portions of an object.

(1) Introduction

As noted above, the present invention relates to temporary freckle tattoo graphics and a set of die lines that facilitate the application of said tattoo. Importantly, the temporary tattoo includes graphics that are formed to mimic freckles when applied to a user's face.

(2) Specific Aspects

This is a temporary tattoo invention with two unique aspects. First, it is a cosmetic and novelty tattoo with graphics that mimic freckles. Temporary tattoos have long been known in the art and are used to apply a variety of graphics to a user. This invention improves upon the traditional temporary tattoo by having graphics that are specifically designed to mimic freckles when applied to a users face. This would be for people who would want to have temporary freckles to make a beauty statement or for novelty purposes. Lately, permanent freckle tattoos have become popular, and this temporary tattoo would allow someone to explore the look of freckles before they make a final decision to get a permanent freckle tattoo.

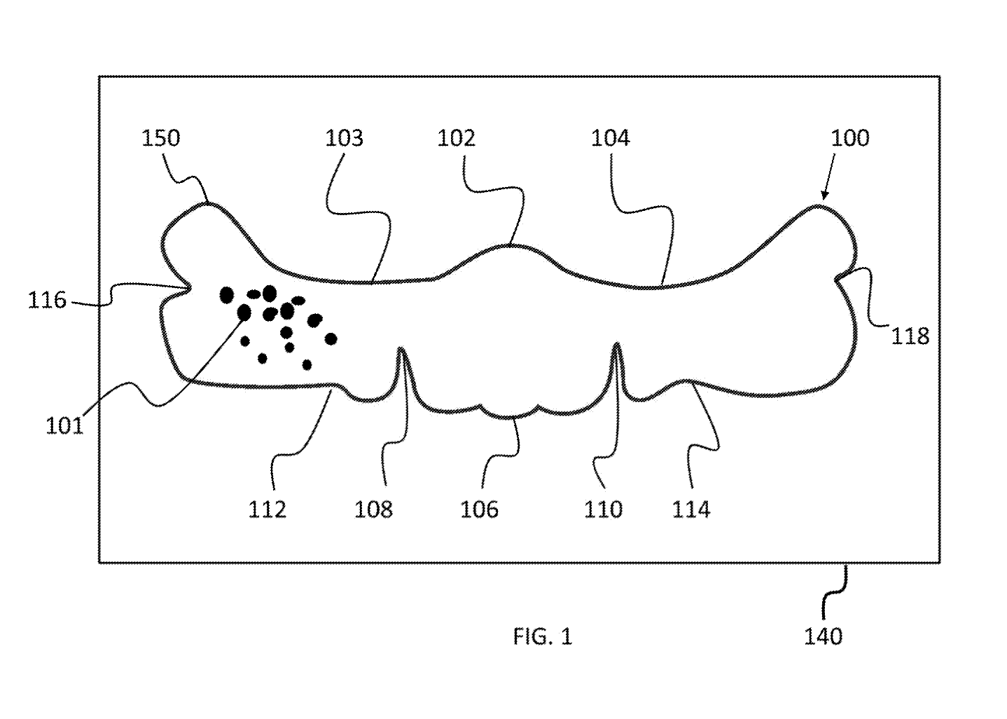

Second and as shown in FIG. 1, the tattoo freckles 101 will come on a sheet 140 with a marked or a kiss cut die-line 150 that is designed and shaped to conform over a person's nose and cheeks. “Marked” means that there is a graphic outline, enclosing the freckled area, which defines the suggested cutting line for the consumer. “Kiss cut” means that it comes on a larger (e.g., rectangular) sheet 140 with the irregularly shaped freckled area mostly cut out (along the die-line 150), at the manufacturing source, except for some small sections that keep the application sheet attached to the rectangular sheet 140. In the case of a marked outline, the end user would cut it out (along the die-line 150) with a pair of scissors. In the case of kiss cutting, the end user would separate the application sheet from the larger sheet 140 along the kiss-cut die line 150 before use. In other words, a user would break and separate the application sheet (along the die-line 150) from the larger sheet 140.

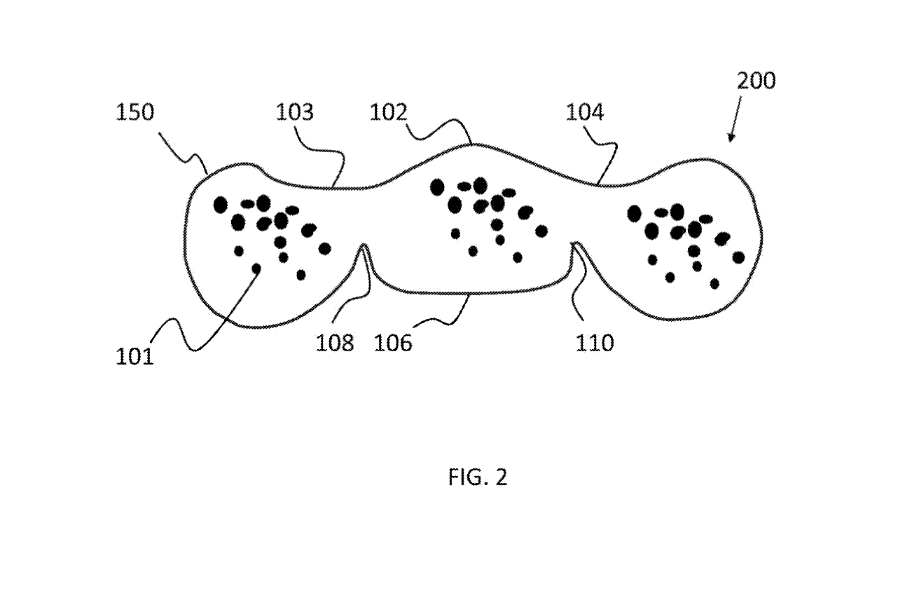

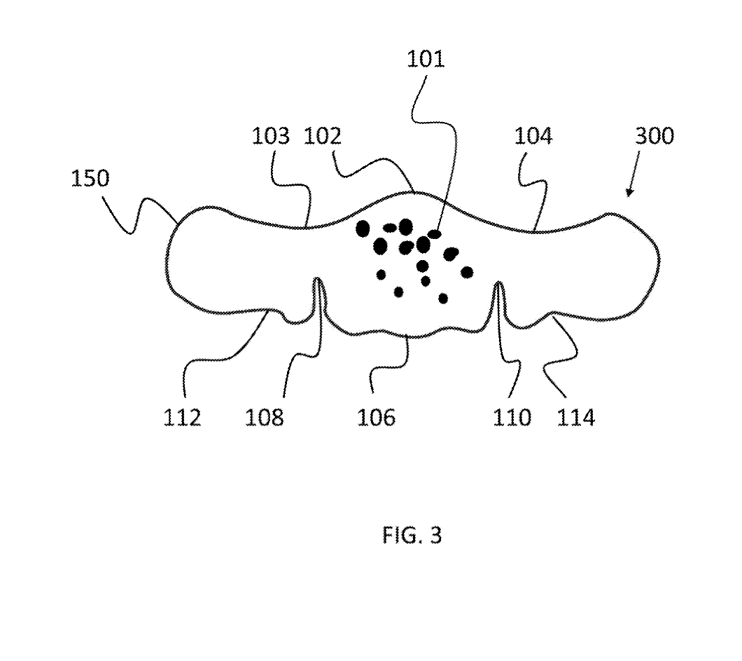

As shown in FIGS. 1 through 4, these irregularly shaped die-line sheets 100, 200, 300, and 400 have a functional purpose and can be formed in a variety of suitable shapes. It should be noted that the illustrations of FIGS. 1 through 4 provide examples of die-lines 150 that are either marked or kiss-cut. Importantly, the applique or die-line sheets 100, 200, 300, and 400 are generally shaped (via the die-line 150) to facilitate the application of the temporary tattoo freckles 101 to a user's face. The sheets 100, 200, 300, and 400 and corresponding temporary tattoo freckles 101 are formed of any suitable material to allow for transfer and application of the temporary tattoo freckles 101, a non-limiting example of which includes the standard materials used for common temporary tattoos. For a specific non-limiting example, the freckles 101 are printed on paper coated with a transfer film. The transfer film allows the image (i.e., temporary freckle 101) to slide off the backing paper and onto the skin when moisture is applied. After drying, the film holds the image on the skin through several washings.

In addition to the temporary tattoo freckle 101, it should he understood that the present invention also includes the sheets 100, 200, 300, and 400 that are shaped to facilitate transfer of the tattoo freckle 101 to the users face. Four non-limiting examples of optional shapes of the sheets 100, 200, 300, and 400 are shown in FIGS. 1 through 4. In one aspect and as shown in the figures, at the center top there is a high point 102 to cover as much of the top of the nose as possible. On each sides of this high point 102 are curved reliefs 103 and 104 that are formed to circumvent the user's eyes. The center bottom 106 extends down to allow maximum coverage of the nostrils and nose tip. Cutaways 108 and 110 are provide on each side of the center bottom 106 to allow the application paper to flex three-dimensionally to conform to the user's nose and cheeks. Additionally, recesses 112 and 114 are included to circumvent or conform to the bumps near the user's nose.

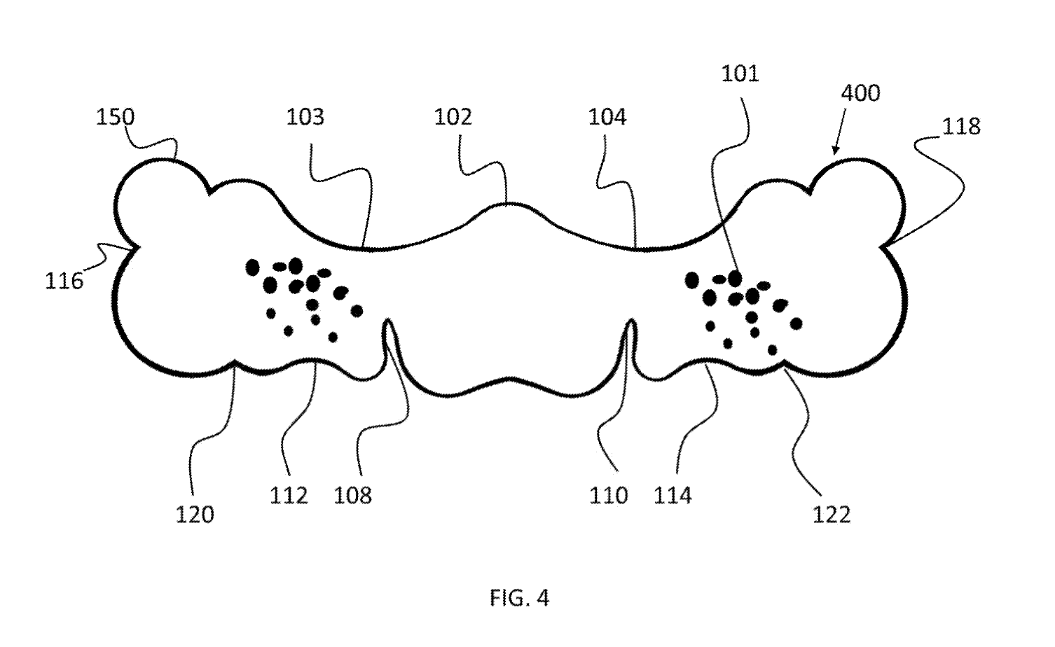

Shallow cutaways shown as items 116 and 118 in FIG. 1 and items 120 and 122 in FIG. 4 provide additional flexibility to conform to the user's face. This marked line or die-cut outline may yet come in additional shapes and sizes to accommodate different freckle densities, different graphics, different face and nose sizes. Thus, as illustrated and as can be appreciated by those skilled in the art, the present invention is generally directed to a sheet having temporary freckle tattoo 101 graphics thereon. The specific sheet shapes (as illustrated throughout FIGS. 1 through 4) can be altered to as desired.

Thus, described are two inventions. The first aspect is a temporary freckle tattoo. The second aspect is the use of a die-line sheet (either marked or die-cut) that is formed to easily conform to it person's face to improve the quality of the application and safely keep the application paper away from the user's eyes.

What is claimed is:

1. A temporary freckle tattoo, comprising:
an application sheet having temporary tattoo graphics thereon, the temporary tattoo graphics being formed to mimic freckles when applied to a user.

2. The temporary freckle tattoo as set forth in claim 1, wherein the application sheet includes a die-line that is shaped to assist application of the application sheet to a user's face.

3. The temporary freckle tattoo as set forth in claim 2, wherein the die-line on the application sheet includes a center high point to allow maximum freckle coverage on top of the user's nose.

4. The temporary freckle tattoo as set forth in claim 3, wherein the die-line on the application sheet includes curved reliefs on each side of the high point to allow the application sheet to circumvent a user's eyes when applied.

5. The temporary freckle tattoo as set forth in claim 4, wherein the die-line on the application sheet includes a center bottom that extends outward to cover a user's nose tip.

6. The temporary freckle tattoo as set forth in claim 5, wherein the die-line on the application sheet includes cutaways formed on each side of the center bottom to allow the application paper to flex three-dimensionally to conform to the user's nose and cheeks.

7. The temporary freckle tattoo as set forth in claim 6, wherein the die-line on the application sheet includes shallow cutaways around its perimeter to allow the application sheet to flex three-dimensionally.

8. The temporary freckle tattoo as set forth in claim 2, wherein the die-line on the application sheet includes a center bottom that extends outward to cover a user's nose tip.

9. The temporary freckle tattoo as set forth in claim 8, wherein the die-line on the application sheet includes cutaways formed on each side of the center bottom to allow the application paper to flex three-dimensionally to conform to the user's nose and cheeks.

10. The temporary freckle tattoo as set forth in claim 2, wherein the die-line on the application sheet includes shallow cutaways around its perimeter to allow the application sheet to flex three-dimensionally.
